(19) United States
(12) Patent Application Publication
(10) Pub. No.: US 2005/0284916 A1
(43) Pub. Date: Dec. 29, 2005

(54) Ball bonding method and ball bonding apparatus

(75) Inventor: Naoki Ishikawa, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/979,248

(22) Filed: Nov. 3, 2004

(30) Foreign Application Priority Data
Jun. 29, 2004 (JP) 2004-191227

(51) Int. Cl. B23K 1/06

(52) U.S. Cl. 228/110.1

(57) ABSTRACT

When ball bonding a thin wire to a work, it is possible to carry out bonding without causing damage to the characteristics of the work. Discharging is carried out between a discharge electrode and the end of a thin wire that projects from a capillary to melt the end of the thin wire and form a bonding ball at the end of the thin wire. The ball is pressed onto the work to bond the thin wire to the work. When discharging is carried out between the discharge electrode and the thin wire to form the ball, discharging is carried out with a discharging position of the discharge electrode and the thin wire set at a position separated from the work by at least a distance at which the characteristics of the work are not damaged by the discharging.

### BACKGROUND OF THE INVENTION

1. Field of the Invention

The present invention relates to a ball bonding method and a ball bonding apparatus, and in more detail relates to a ball bonding method and a ball bonding apparatus that carry out bonding without damaging a work.

2. Related Art

Ball bonding is a method of joining a thin wire and a work where an end part of the thin wire is melted to form a ball that is connected to a bonding position on the work by thermocompression bonding or a combination of ultrasound and thermocompression bonding.

As examples, ball bonding is used when forming electrode protrusions (bumps) on electrode terminals of a semiconductor chip to manufacture a semiconductor chip for flip-chip connecting and in a head assembly process of a hard disk drive when connecting electrodes of a magnetic head with suspension electrodes by bonding.

FIGS. 6A and 6B show a method of forming a ball 10a for bonding at the end of a thin wire 10 when ball bonding. That is, the thin wire 10 is supplied having been passed through a capillary 12 of a bonding tool, and in a state where the end of the thin wire 10 projects out from the end of the capillary 12, electrical discharging is carried out between the thin wire 10 and a discharge electrode 14 so that the thin wire 10 melts (FIG. 6A) and a bonding ball 10a is formed at the end of the thin wire 10 by surface tension (FIG. 6B). The size of the ball 10a is controlled by the voltage value, the current value, and the discharge time during the electrical discharge, and normally the separation gap between the discharge electrode 14 and the thin wire 10 is 1 mm to 1.5 mm and the discharge voltage is 4000 to 5000V.

FIGS. 7A and 7B show a method of forming bumps 16 on a work 15 such as a semiconductor chip by a ball bonding method. Discharging is carried out between the thin wire 10 and the discharge electrode 14 directly above the bonding position on the work 15 to form a ball 10a at the end of the thin wire 10 and after the ball 10a has been pressed onto and bonded to the work 15 by the capillary 12, the capillary 12 is raised and the thin wire 10 snaps to form a bump 16 (see FIG. 7A). The ball 10a has a flattened shape due to the pressing action of the capillary 12, and since the thin wire 10 snaps as it is pulled upwards, a protrusion is formed at a peak of the bump 16.

In this way, when ball bonding, first discharging is carried out between the thin wire 10 and the discharge electrode 14 to melt the thin wire 10 and form the ball 10a. In this case, the majority of the discharged energy is concentrated at the end of the thin wire 10 as energy for forming the ball 10a, but since a large voltage is applied between the discharge electrode 14 and the thin wire 10 and the discharging is carried out in air, depending on various conditions such as the distance between the work 15 and the discharge electrode 14 and the shape of the work 15, a small amount of discharge energy sometimes acts towards the work 15.

In this case, when the withstand voltage of the work 15 is low, the work 15 can be damaged by even a small amount of discharge energy, resulting in problems such as the required characteristics not being obtained, fluctuations in the resistance, and the work becoming defective.

### SUMMARY OF THE INVENTION

The present invention was conceived in order to solve the problem described above, and it is an object of the present invention to provide a ball bonding method and a ball bonding apparatus that can bond a thin wire without damaging a work when forming bumps on a work using a thin wire or bonding a thin wire.

To achieve the stated object, a ball bonding method according to the present invention includes steps of: discharging between a discharge electrode and an end of a thin wire that projects from a capillary to melt the end of the thin wire and form a bonding ball at the end of the thin wire; and pressing the ball onto a work to bond the thin wire to the work, wherein when the step of discharging is carried out between the discharge electrode and the thin wire to form the ball, discharging is carried out with a discharging position of the discharge electrode and the thin wire set at a position separated from the work by at least a distance at which characteristics of the work are not damaged by the discharging.

During a bonding operation, the discharging position may be fixed at a predetermined position separated from the work by a predetermined distance.

Alternatively, during a bonding operation, the discharging position may be set so as to follow a movement position to which a head unit of a bonding apparatus moves. By doing so, efficient bonding is possible.

The discharging position may be set on a movement path of the head unit of the bonding apparatus with the head unit being in a moving state. By doing so, even more efficient bonding is possible.

Also, a windshield unit that prevents discharging errors due to wind pressure may be provided on the head unit of the bonding apparatus.

A ball bonding apparatus that uses any of the ball bonding methods described above can reliably carry out ball bonding without causing damage to a work.

With the ball bonding method and the ball bonding apparatus according to the present invention, it is possible to reliably carry out bonding with no loss in the characteristics of the work, so that the production of defective products can be suppressed and ball bonding can be carried out reliably for works with low withstand voltages and the like.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a diagram that schematically shows the construction of a ball bonding apparatus;

FIG. 2 is a diagram useful in explaining a first embodiment of a ball bonding method;

FIG. 3 is a diagram useful in explaining a second embodiment of a ball bonding method;

FIG. 4 is a diagram useful in explaining a third embodiment of a ball bonding method;

FIG. 5 is a diagram useful in explaining an example where a windshield plate is provided on a discharge electrode;

FIGS. 6A and 6B are diagrams useful in explaining a method of forming a ball at an end of a thin wire; and

FIGS. 7A and 7B are diagrams useful in explaining a method of forming bumps on a substrate.

### DETAILED DESCRIPTION OF THE EMBODIMENTS

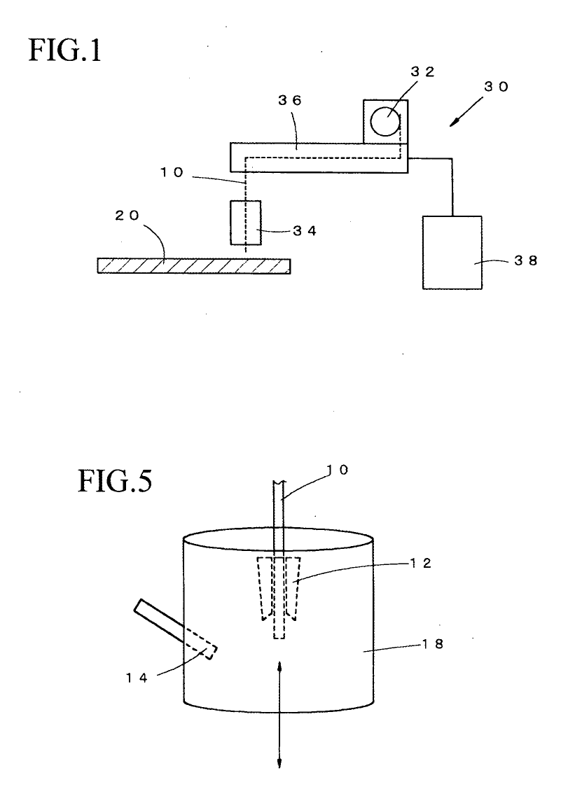

FIG. 1 schematically shows the construction of a bonding apparatus 30 that bonds a thin wire to a work 20 using a bonding method according to the present invention. The bonding apparatus 30 includes a thin wire supplying unit 32 that supplies a thin wire 10 to be bonded to the work 20, a head unit 34 that bonds the thin wire 10 to the work 20, a moving mechanism unit 36 that moves and positions the head unit 34 at a predetermined position, and a control unit 38 that controls the supplying unit 32, the head unit 34, and the moving mechanism unit 36. The head unit 34 is provided with a capillary 12 and a discharge electrode 14, and the control unit 38 controls the discharge timing of the capillary 12 and the discharge electrode 14.

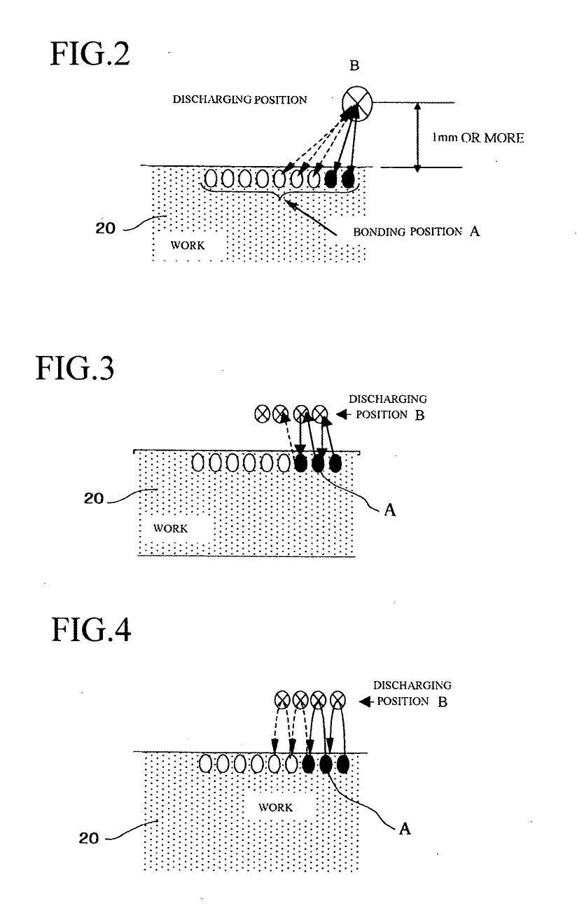

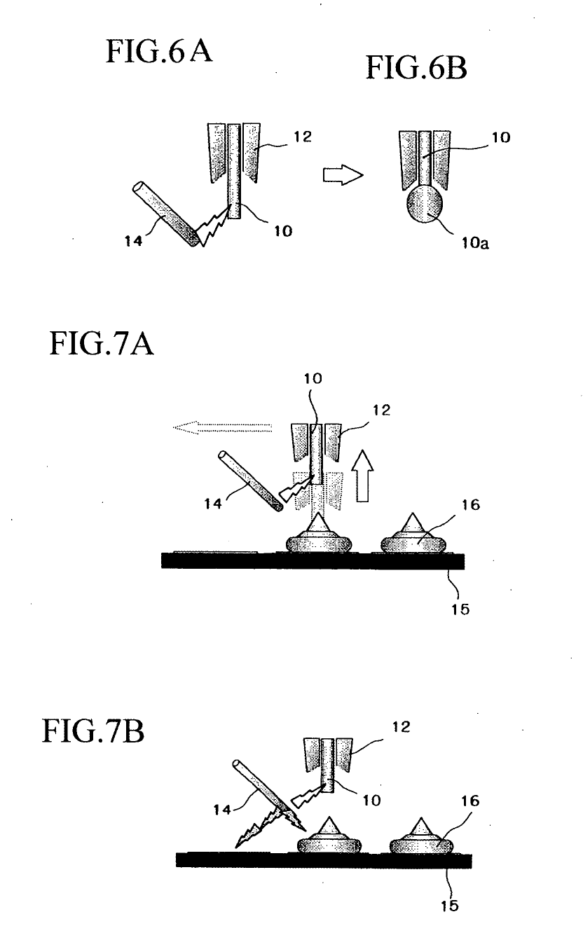

FIG. 2 is a diagram useful in explaining a first embodiment of a ball bonding method according to the present invention. The present embodiment is characterized by carrying out bonding as follows. When forming bumps at bonding positions A of the work 20, a discharging position B for carrying out discharging between the thin wire 10 and the discharge electrode 14 to form a ball 10a at the end of the thin wire 10 is set at a position separated from the work 20 by a predetermined distance, so that when discharging occurs between the thin wire 10 and the discharge electrode 14, the characteristics of the work 20 are not damaged.

It should be noted that a method for forming bumps on the work 20 using a thin wire is the same as the method shown in FIGS. 7A and 7B, so that discharging is carried out between the discharge electrode 14 and the end of the thin wire 10 that projects from the capillary 12 to form a ball 10a at the end of the thin wire 10, the capillary 12 is lowered to a bonding position, the ball 10a is pressed onto and bonded to the work 20 by the capillary 12, and then the capillary 12 is raised so that the thin wire 10 is snapped off the bump.

Since the bonding positions A are set on the work 20 at predetermined intervals, bumps are successively formed by positioning the head unit 34 of the bonding apparatus 30 at the respective bonding positions A.

The ball bonding method of the present embodiment is a method that sets a discharging position B at a predetermined position that is separated from the work 20 by a predetermined distance and uses a fixed discharging position.

In the bonding apparatus 30, the discharge electrode 14 and the capillary 12 are both provided so as to be movable, and in each bonding operation, the capillary 12 and the discharge electrode 14 can be made to return to the discharging position B before discharging occurs. However, it is also possible to provide the discharge electrode 14 and the capillary 12 as separate constructions, with the discharge electrode 14 being fixed at the discharging position B and only the capillary 12 moving back and forth between the bonding positions and the discharging position B, with discharging between the thin wire 10 and the discharge electrode 14 being carried out when the capillary 12 has returned to the discharging position B.

In the ball bonding method according to the present embodiment, the discharging position B between the thin wire 10 and the discharge electrode 14 is set at a position separated from the work 20 by a predetermined distance so that the work 20 is not damaged by the discharging between the thin wire 10 and the discharge electrode 14, so that the discharging operation does not damage the work 20 or cause fluctuations in the characteristics of the work 20, which means that ball bonding can be carried out without adversely affecting the quality of the work 20.

It should be noted that the gap that separates the work 20 and the discharging position B and the location of the discharging position B with respect to the work 20 can be set as appropriate in accordance with factors such as the withstand voltage of the work 20 and the shape of the work 20 in a range within which the head unit 34 of the bonding apparatus 30 can move.

The discharging position B can be disposed directly above the bonding surface of the work 20 as shown in FIG. 2, and can alternatively be disposed at a position at some distance to the side of the work 20. Depending on the withstand voltage and/or other characteristics that are individual to respective works 20, the discharging position B may be disposed so as to be separated from the work 20 by 1 mm or more.

FIG. 3 is a diagram useful in explaining a second embodiment of a ball bonding method according to the present invention. In the first embodiment described above, the discharging position B is set at a predetermined fixed position with respect to the work 20, but this second embodiment is characterized in that bonding is carried out so that when the head unit 34 of the bonding apparatus 30 successively moves in accordance with the bonding positions on the work 20, the discharging position B simultaneously moves so as to follow the movement of the head unit 34.

In the present embodiment, in the same way as the first embodiment, the discharging positions B where discharging is carried out between the thin wire 10 and the discharge electrode 14 are set at positions that are separated from the work 20 by a predetermined distance so that the work 20 is not damaged by the discharging.

In the ball bonding operation shown in FIG. 3, after a ball 10a has been bonded to the work 20, the head unit 34 is moved to a position directly above the next adjacent bonding position, discharging is carried out between the thin wire 10 and the discharge electrode 14 at the discharging position B directly above this bonding position to form the ball 10a, and the capillary 12 is then lowered to bond the ball 10a to the work 20.

In reality, the capillary 12 and the discharge electrode 14 are provided on the head unit 34 of the bonding apparatus 30 and the head unit 34 is moved so that the capillary 12 moves towards and away from the work 20 and the discharge electrode 14 is kept at a predetermined distance from the work 20. When the capillary 12 has returned to a discharging position, discharging is carried out between the thin wire 10 and the discharge electrode 14.

In this way, bonding is carried out so that in accordance with the operation that moves the head unit 34 along the bonding positions of the work 20, the discharging position B moves while maintaining a separation gap between the work 20.

With the ball bonding method according to the present embodiment, bonding can be carried out without adversely affecting the work 20, and bonding is carried out while moving the discharging position B together with the head unit 34 of the bonding apparatus 30, so that bonding can be carried out efficiently. It should be noted that the head unit 34 of the bonding apparatus 30 in the present embodiment moves in a straight line between the bonding positions A and the discharging positions B.

FIG. 4 is a drawing useful in explaining a third embodiment of a ball bonding method according to the present invention. Like the second embodiment, in this third embodiment bonding is carried out with the discharging position B moving together with the bonding position on the work 20 every time bonding is carried out. However, although discharging between the thin wire 10 and the discharge electrode 14 is carried out with these parts in a stationary state in the second embodiment, in the third embodiment, discharging is carried out with the head unit 34 of the bonding apparatus 30 in a moving state without stopping on a movement path on which the head unit 34 moves.

In FIG. 4, an operation is shown where the head unit 34 moves between adjacent bonding positions A so as to trace a loop-shaped path, with discharging being carried out between the thin wire 10 and the discharge electrode 14 midway on this movement path and then bonding being carried out at the next bonding position.

Since discharging is carried out between the thin wire 10 and the discharge electrode 14 without stopping the movement of the head unit 34, the movement path and the discharge timing are controlled so that discharging is carried out at a position where the work 20 is not subjected to damage, that is, a position separated from the work 20 by a predetermined distance or more.

With the present embodiment, discharging is carried out between the thin wire 10 and the discharge electrode 14 on the movement path with the head unit 34 in a moving state to form a ball 10a, so that compared to the second embodiment, bonding can be carried out with even higher efficiency.

It should be noted that in the case where discharging is carried out with the head unit 34 of the bonding apparatus 30 in a moving state as described above, the discharging direction may be affected by wind pressure. FIG. 5 shows one example where a windshield unit 18 is provided on the head unit 34 so that the discharging direction is not affected by wind pressure.

The windshield unit 18 shown in FIG. 5 is an example where a windshield plate in the form of a cylindrical tube that is open in the direction of movement of the capillary 12 is attached to the head unit 34 and provided so as to shield a discharge region between the discharge electrode 14 and the thin wire 10. By providing this windshield unit 18, when discharging is carried out with the head unit 34 of the bonding apparatus 30 in a moving state, the discharging direction is prevented from becoming oriented towards the work 20 due to wind pressure, so that it is possible to reliably carry out discharging between the discharge electrode 14 and the thin wire 10.

It should be noted that although an example where bumps are formed on the work 20 by ball bonding has been described in the above embodiments, the ball bonding method according to the present invention is not limited to the case where ball-shaped connecting parts are formed, and can be applied to other types of connections, such as wire bonding. In the case of wire bonding and the like, by using the method of the present invention, it is possible to carry out bonding without causing damage to a work.

1. A ball bonding method, comprising steps of:
discharging between a discharge electrode and an end of a thin wire that projects from a capillary to melt the end of the thin wire and form a bonding ball at the end of the thin wire; and
pressing the ball onto a work to bond the thin wire to the work,
wherein when the step of discharging is carried out between the discharge electrode and the thin wire to form the ball, discharging is carried out with a discharging position of the discharge electrode and the thin wire set at a position separated from the work by at least a distance at which characteristics of the work are not damaged by the discharging.

2. A ball bonding method according to claim 1,
wherein during a bonding operation, the discharging position is fixed at a predetermined position separated from the work by a predetermined distance.

3. A ball bonding method according to claim 1,
wherein during a bonding operation, the discharging position is set so as to follow a movement position to which a head unit of a bonding apparatus moves.

4. A ball bonding method according to claim 3,
wherein the discharging position is set on a movement path of the head unit of the bonding apparatus with the head unit being in a moving state.

5. A ball bonding method according to claim 4,
wherein a windshield unit that prevents discharging errors due to wind pressure is provided on the head unit of the bonding apparatus.

6. A ball bonding apparatus that uses a ball bonding method according to any of claims 1 to 5.
